(19) United States
(12) Patent Application Publication
(10) Pub. No.: US 2011/0218901 A1
(43) Pub. Date: Sep. 8, 2011

(54) ON-LINE PRODUCT AUCTION METHOD USING STOCK INDEX AND RECORDING MEDIUM

(76) Inventor: Keun Soo Yun, Seoul (KR)

(21) Appl. No.: 12/810,145

(22) PCT Filed: Jan. 4, 2008
(86) PCT No.: PCT/KR08/00043

§ 371 Date: Jun. 22, 2010

(30) Foreign Application Priority Data
Jan. 5, 2007 (KR) 10-2007-0001274

(51) Int. Cl. G06Q 40/00

(52) U.S. Cl. 705/37

(57) ABSTRACT

An online product auction method using stock price indexes is disclosed. A plurality of bidders participates in online auction bidding for a presented product and inputs respective bid numbers. Specific numbers are extracted from two or more indexes which indicate stock prices. A successful bid number is created by combining the extracted numbers in a predetermined sequence. It is determined whether a bid number identical to the successful bid number exists among the bid numbers. If one or more bid numbers identical to the successful bid number exist, an earliest bidder is selected for a successful bidder. If no bid number identical to the successful bid number exists, an earliest bidder, having a bid number which is the closest to the successful bid number, is selected for a successful bidder. Thereafter, a command is output to deliver the corresponding product to the selected bidder.

### TECHNICAL FIELD

The present invention relates, in general, to an online product auction method, and, more particularly, to an online product auction method using stock price indexes, and a recording medium.

### BACKGROUND ART

Generally, a lowest-price bidding system, in which bid prices are offered as selling prices for a specific product (for example, a Moving Picture Experts Group (MPEG) Audio Layer-3 (MP3) player), has been widely conducted online, such as over the Internet. A reverse auction bidding system, in which selling prices are offered as purchase prices for a specific product, has been also utilized.

Meanwhile, various types of services, which allow cyber money to be increased/decreased or awarded using various types of lotteries, games, participation in events, and the viewing of advertisements, have been provided over the Internet.

However, the various types of online services over the Internet have a lot of problems, such as the pursuit of an advertisement effect based on the fabrication of data and winning bidders, and provide cases in which fairness is frequently doubted.

Further, in the case in which there is a plurality of winning bidders, products or services are provided to the winning bidders in such a way as to equally distribute or equally divide the products or services based on the number of the winning bidders, so that it is difficult to discriminate the differences between winning bidders in the case in which there are a large number of participants.

### DISCLOSURE OF INVENTION

### Technical Problem

Accordingly, the present invention has been made keeping in mind the above problems occurring in the prior art, and an object of the present invention is to provide an online product auction method using stock price indexes, which can earn the trust of the public by basically using various types of stock price indexes officially announced online, such as over the Internet, and which can promote participation in bidding by selecting the earliest bidder for a winning bidder in the case in which there is a plurality of successful bidders, and a recording medium.

### Technical Solution

In order to accomplish the above object, the present invention provides an online product auction method using stock price indexes, the method including an input step of a plurality of bidders participating in online auction bidding for a presented product and inputting respective bid numbers; an extraction step of extracting specific numbers from two or more indexes which indicate stock prices; a creation step of creating a successful bid number by combining the extracted numbers in a predetermined sequence; a determination step of determining whether a bid number identical to the successful bid number exists among the bid numbers; a selection step of selecting the earliest bidder for a successful bidder if one or more bid numbers identical to the successful bid number exist, and selecting the earliest bidder having the closest number for a successful bidder if no bid number identical to the successful bid number exists; and an output step of outputting a command to deliver the corresponding product to the selected bidder.

According to an aspect of the present invention, the two or more indexes are selected from any of a group including the KOrea composite Stock Price Index (KOSPI) index and KOrea Securities Dealers Automated Quotation (KOSDAQ) index of Korea, a group including the Dow Jones index and National Association of Securities Dealers Automated Quotation (NASDAQ) index of America, and a group including the Nikkei index and Japan Association Of Securities Dealers Automated Quotation (JASDAQ) index of Japan.

According to another aspect of the present invention, the creation step includes a step of extracting first and second digits after the decimal point of a daily stock price index and first and second digits after the decimal point of a price change from a previous day's closing; and a step of creating a four-digit successful bid number by combining the extracted numbers.

According to further another aspect of the present invention, the determination step further includes a step of each of the bidders paying a predetermined bid participation fee or cyber money online.

According to still another aspect of the present invention, the input step is allowed such that the input is possible only for a predetermined time; and the extraction step is executed after the predetermined time has elapsed.

In order to accomplish the above object, the present invention provides a computer readable, executable recording medium storing a program code for enabling a plurality of bidders to participate in an online auction bidding for a presented product and input respective bid numbers; a program code for extracting specific numbers from two or more indexes selected from any of a group including the KOSPI index and KOSDAQ index of Korea, a group including the Dow Jones index and NASDAQ index of America, and a group including the Nikkei index and JASDAQ index of Japan; a program code for creating a four-digit successful bid number by combining the extracted numbers; a program code for determining whether a bid number identical to the successful bid number exists among the bid numbers; a program code for selecting the earliest bidder for a successful bidder if a bid number identical to the successful bid number exists, and selecting the earliest bidder having almost the same bid number for a successful bidder if no bid number identical to the successful bid number exists; and a program code for outputting a command to deliver the corresponding product to the selected bidder.

Features and advantages of the present invention will be more clearly understood from the following detailed description, taken in conjunction with the accompanying drawings. Herein, terms and words used in the present specification and claims must not be interpreted as having common and dictionary meanings, but should be interpreted as having meanings and concepts in conformity with the technical spirit of the present invention based on the principle in which an inventor can appropriately define the concepts of terms in order to describe the inventor's own invention in the most appropriate way.

### Advantageous Effects

An online product auction method using stock price indexes according to the present invention can earn the trust of the public by basically using various types of stock price indexes officially released online, that is, over the Internet. Therefore, the reliability of service to be provided can be improved and various types of dissatisfaction can be eliminated.

Further, in the case in which there is a plurality of successful bidders, the earliest bidder is selected as a successful bidder, so that participation in bidding can be promoted. Accordingly, bidders are promoted to participate in bidding as soon as possible, so that service can be easily utilized.

Although the present invention will be described with reference to the above-described preferred embodiments of the present invention, it will be apparent to those skilled in the art that various modifications and adjustments of the embodiments are possible without departing from the gist of the present invention. Accordingly, it is apparent that such modifications and adjustments are included in the scope of the accompanying claims.

### BRIEF DESCRIPTION OF THE DRAWINGS

FIG. 1 is a configuration table showing a KOrea composite Stock Price Index (KOSPI) index and a KOrea Securities Dealers Automated Quotation (KOSDAQ) index which are selected and used according to an embodiment of the present invention;

FIG. 2 is an auction time table according to an embodiment of the present invention;

FIG. 3 is an auction bidding record table showing the case in which a bid number is identical to a successful bid number, so that a corresponding bidder makes a successful bid according to an embodiment of the present invention;

FIG. 4 is an auction bidding record table showing the case in which two or more bid numbers identical to a successful bid number make a successful bid, so that the earliest bidder is determined to make the successful bid according to an embodiment of the present invention;

FIG. 5 is an auction bidding record table showing the case in which two or more bid numbers close to a successful bid number make a successful bid, so that the earliest bidder makes a successful bid according to an embodiment of the present invention; and

FIG. 6 is a diagram showing the configuration of an Internet system in which a product auction method according to the present invention is operated.

### DESCRIPTION OF PRINCIPAL REFERENCE CHARACTERS OF DRAWINGS

10: Daily KOSPI index
12: Price change from the previous day's close of a KOSPI index
14: Daily KOSDAQ index
16: Price change from the previous day's close of a KOSDAQ index
50: Internet 60: Server device
70: Client computer 100: Auction time table
110: Time table for respective days 120: Bid period for auction game
130: Successful bid day stock price index
140: Entire bid information announcement date and hour
200, 300, 400: Auction bidding record table
210, 310, 410: Bidder ID
220, 320, 420: Bid date and hour 230, 330, 430: Bid number
240: Bid number of the successful bidder
340: Bid number of the earliest bidder
350: Bid number of a subsequent bidder
440: Earliest bidder's bid number close to a successful bid number
450: Subsequent bidder's bid number close to a successful bid number

### BEST MODE FOR CARRYING OUT THE INVENTION

The object, features, and advantages of the above-described present invention will be more apparent from the detailed description below.

Hereinafter, preferred embodiments of an online product auction method using stock price indexes and a recording medium therefore according to the present invention will be described in detail with reference to the attached drawings.

First, reference should now be made to the drawings, in which the same reference numerals are used to designate the same configuration elements or components. Detailed descriptions of well-known functions and configurations related to the description of the present invention will be omitted in order to prevent the gist of the present invention from being obscured.

FIG. 6 is a diagram showing the configuration of an Internet system in which the product auction method according to the present invention is operated. As shown in the drawing, a server device 60 is connected to a plurality of client computers 70 over the Internet 50, so that data communication is possible therebetween.

The server device 60 includes a World Wide Web (WWW) server for managing a particular homepage. Further, the server device 60 is a device in which respective methods, which will be described according to the present invention, are performed.

Such a client computer 70 is a computer which a bidder can use to input or check data. The client computer 70 may be a personal computer.

First, a step of a bidder inputting a bid number will be described. Various types of products (for example, an MP3 player) are suggested on a homepage operated by the server device 60. A bidder joins as a member, logs on, and then participates in bidding by selecting a desired product. When the bidder joins as a member, the bidder inputs basic information, such as Identification (ID), a password, a mobile phone number, and an E-mail, and then inputs an address to which a product is to be delivered, and means for payment (electric remittance, payment via a mobile phone, payment via credit card, or cyber money).

A fee for one bid, which is charged when the bidder makes a bid, may be, for example, 1,000 won. The bid price is automatically withdrawn from a payment account whenever a bid is made. If a product offered in an auction is an MP3 player and the customer price thereof is 250,000 won, the auction is valid only when the number of participation in bidding is at least 250 or more during a given auction period (for example, during a week).

The bidder can select and input a desired number from among numbers in the range of 0000 to 9999. The range of the number can be adjusted by the server device 60.

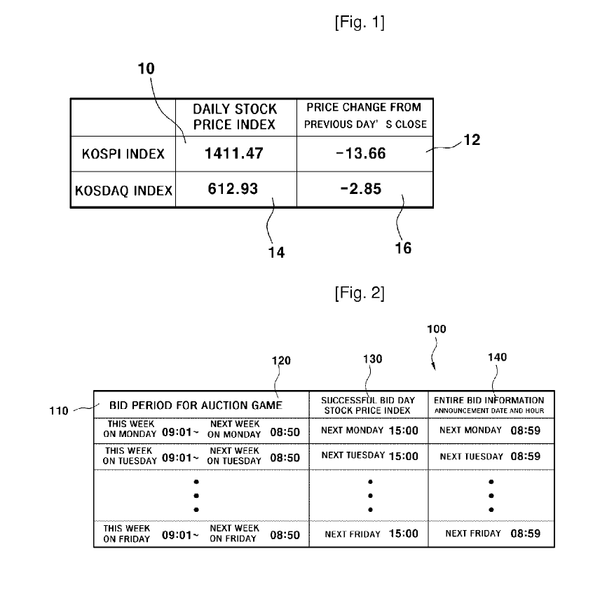

Next, a process of creating a successful bid number using various types of stock price indexes will be described. FIG. 1 is a configuration table showing a KOSPI index and a KOSDAQ index, which are selected according to an embodiment of the present invention. First, the KOSPI index refers to stock price indexes related to respective companies traded by being listed in the marketable securities of the Korea Stock Exchange, and the KOSDAQ index refers to the stock price indexes of stock markets for small and medium-sized companies and venture companies. Such stock price indexes are collected in real time and then officially announced at 3 p.m. every day. That is, since the stock price indexes are announced by organizations in which the public has confidence, there is no doubt about the KOSDAQ index and the KOSPI index.

As shown in FIG. 1, for example, the Daily KOSPI index is 1411.47 and the Daily KOSDAQ index is 612.93. In addition, for the KOSPI index, the price change from the previous day's closing is −13.66 and, for the KOSDAQ index, the price change from the previous day's closing is −2.85. A process of creating a successful bid number using various types of stock price indexes, announced as described above, will be described.

First, the server device 60 receives various types of stock price information over the Internet 50. Next, as a first example, second digits after the decimal point of a KOSPI index are combined with second digits after the decimal point of the price change from the previous day's close of the KOSPI index (in this case, “47” and “66”), so that a successful bid number (for example, “4766”) is created. As a second example, second digits after the decimal point of a KOSDAQ index are combined with second digits after the decimal point of the price change from the previous day's close of the KOSDAQ index (in this case, “93” and “85”), so that a successful bid number (for example, “9385”) is created. As a third example, the second digits after the decimal point of the price change from the previous day's close of the KOSPI index are combined with the second digits after the decimal point of the price change from the previous day's close of the KOSDAQ index (in this case, “66” and “85”), so that a successful bid number (for example, “6685”) is created. As a fourth example, the second digits after the decimal point of the KOSPI index are combined with the second digits after the decimal point of the KOSDAQ index (in this case, “47” and “93”), so that a successful bid number (for example, “4793”) is created. In addition, other combinations can be made in reverse order for number arrangement between the indexes or number arrangement between the index and the price change from the previous day's close of the index. Hereinafter, embodiments will be described using the successful bid number “4766”.

FIG. 2 shows an auction time table according to an embodiment of the present invention. As shown in the drawing, an auction time table 100 is formed in units of a week (this week on Monday 09:01 to next week on Monday 08:50), and listed as a time table 110 for respective days (for example, for Monday, for Tuesday, . . . , and for Friday). Further, for respective days, a successful bid day stock price index 130 and entire bid information announcement dates and hours 140 are displayed.

As shown in FIG. 2, the time at which bidding ends is “next week on Monday 08:50”, and the time at which the successful bid day stock price index is announced is “next week on Monday 15:00”. That is, it is known that the stock price index is announced after the bidding is ended. That is, since information or data about the bidding cannot be fabricated, the reliability and fairness of the bidding are increased.

Hereinafter, each process of making a successful bid will be described based on the created successful bid number “4766”.

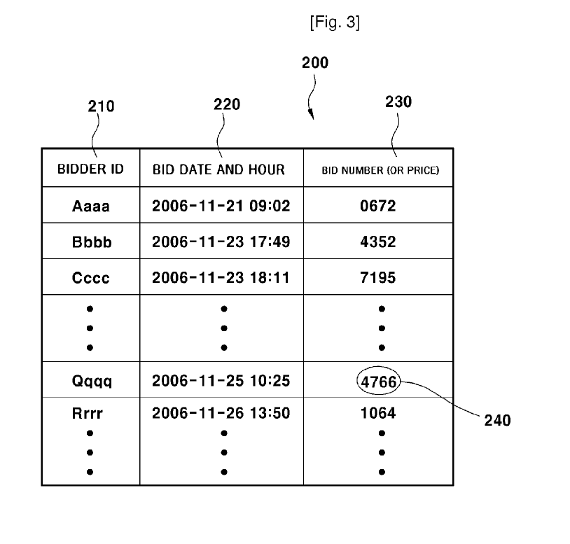

First, FIG. 3 is an auction bidding record table 200 showing the case in which a bid number is identical to a successful bid number, so that a corresponding bidder makes a successful bid according to an embodiment of the present invention. As shown in the drawing, a bidder ID 210, bid date and hour 220, and a bid number 230 are displayed in the auction bidding record table 200. In particular, in the bid date and hour field 220, the time at which a bidder made a bid is input and displayed in minutes (or seconds).

The bid number 230 is a four-digit Arabic number which the bidder input using his/her client computer 70. For example, if a successful bid number is “4766” in FIG. 3, a bidder “Qqqq”, who input the number (“4766”) the same as the successful bid number, makes a successful bid. In FIG. 3, reference numeral “240” indicates the bid number (“4766”) of the successful bidder. Since the other bidders input different bid numbers, they are rejected in the bidding.

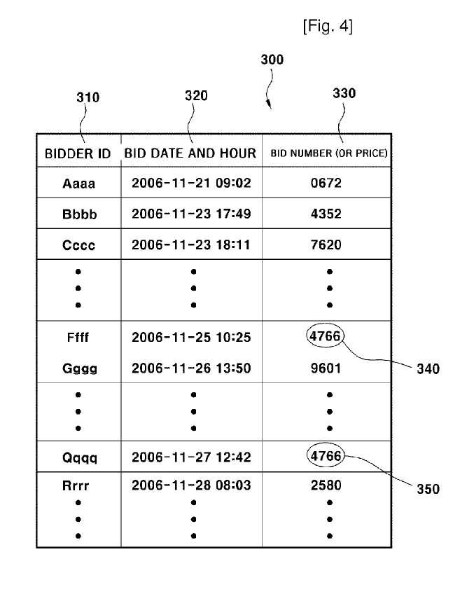

FIG. 4 is an auction bidding record table 330 showing the case in which two or more bid numbers identical to a successful bid number make a successful bid, so that the earliest bidder is determined to make the successful bid according to an embodiment of the present invention. As shown in FIG. 4, it is known that there are two bidders each having the bid number (“4766”) identical to the successful bid number. In this case, the bidding date and hour 320 are determined, and the earliest bidder makes a successful bid. In the case of FIG. 4, the successful bid number of a bidder having an ID “Ffff” makes a successful bid as the bid number of the earliest successful bidder 340. Further, the successful bid number of a bidder having an ID “Qqqq” is the bid number of a subsequent successful bidder 350, thereby being rejected. The above-described examples are identically applied in the case in which there are three or more bidders who input the same bid number.

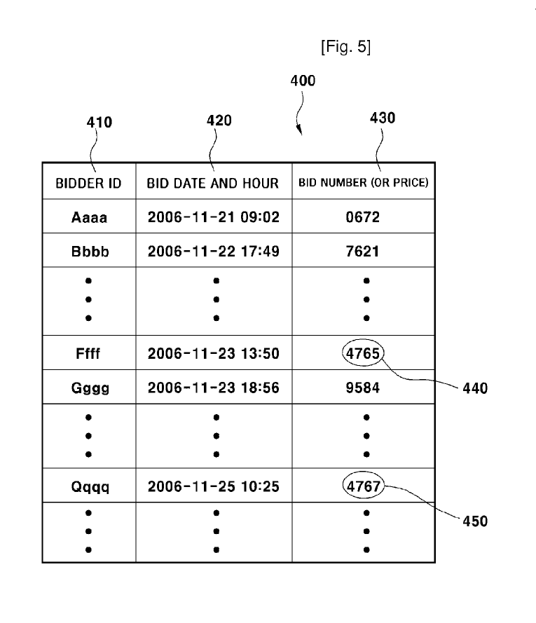

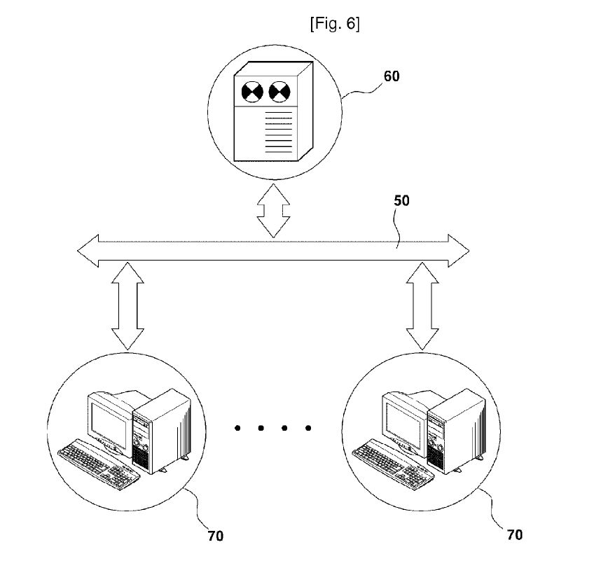

FIG. 5 is an auction bidding record table 400 showing the case in which two or more bid numbers close to a successful bid number make a successful bid, so that the earliest bidder makes a successful bid according to an embodiment of the present invention. As shown in FIG. 5, although the successful bid number is “4766”, there is no bidder who input “4766” as a bid number. Therefore, the people who input the closest number to the number “4766” are a user “Ffff” who input “4765” and a user “Qqqq” who input “4767”. However, in this case, the number “4765”, input by the user “Ffff”, is determined to be the successful bid, because the number “4765” is the earliest bidder's bid number 440 close to a successful bid number, and the number “4767”, input by the user “Qqqq”, is rejected because it is a subsequent bidder's bid number 450 close to a successful bid number.

Next, if a successful bidder is selected, a command is output so as to deliver the corresponding product to the mail delivery address of the successful bidder. The command may be a signal, transmitted to a delivery company, or a print command which causes a printer to output a delivery address. When the delivery command is completed, the delivery of the product to the corresponding address is performed by a deliveryman.

Bidding information, input by respective bidders, is not opened, and the bidders can read only their own information. All bidding information is announced to all bidders at a predetermined time, that is, after the bid closing time and before the stock market opening time 09:00 of a successful bid date, so that whether the bidders make a successful bid can be determined using the closing stock price index announced at 15:00 on the successful bid date.

Although the present invention has incorporated a group including the KOSDAQ index and the KOSPI index, any index group which is announced by a public institution, such as a group including the Dow Jones index and National Association of Securities Dealers Automated Quotation (NASDAQ) index of America and a group including the Nikkei index and Japan Association Of Securities Dealers Automated Quotation (JASDAQ) index of Japan, can be used.

A recording medium according to the present invention can be read by a computer. Further, a series of commands can be recorded in the recording medium. The recording medium may be, for example, a floppy disk, a hard disk, a magnetic reel tape, an optical disk (an optical disk including a Compact Disc (CD), a Digital Versatile Disc (DVD), and a Blu-ray Disc), and semiconductor memory (memory including Random Access Memory (RAM), Read-Only Memory (ROM), Electrically Erasable Programmable Read-Only Memory (EEPROM), Universal Serial Bus (USB) memory, Compact Flash (CF) memory, and Secure Digital (SD) memory). However, the recording medium according to the present invention is not limited to the above-described media, and should be interpreted as any types of media in which electric data can be recorded, preserved, and read.

The above-described present invention is not limited to the above-described embodiments and the accompanying drawings, and it will be apparent to those skilled in the art that variations, modifications, and adjustments of the above-described embodiments are possible without departing from the technical scope of the present invention.

1. An online product auction method using stock price indexes, the method comprising:
an input step of a plurality of bidders participating in online auction bidding for a presented product and inputting respective bid numbers;
an extraction step of extracting specific numbers from two or more indexes which indicate stock prices;
a creation step of creating a successful bid number by combining the extracted numbers in a predetermined sequence;
a determination step of determining whether a bid number identical to the successful bid number exists among the bid numbers;
a selection step of selecting an earliest bidder for a successful bidder if one or more bid numbers identical to the successful bid number exist, and selecting an earliest bidder having a closest number for a successful bidder if no bid number identical to the successful bid number exists; and
an output step of outputting a command to deliver the corresponding product to the selected bidder.

2. The online product auction method according to claim 1, wherein the two or more indexes are selected from any of a group including a KOrea composite Stock Price Index (KOSPI) index and a KOrea Securities Dealers Automated Quotation (KOSDAQ) index of Korea, a group including a Dow Jones index and a National Association of Securities Dealers Automated Quotation (NASDAQ) index of America, and a group including a Nikkei index and a Japan Association Of Securities Dealers Automated Quotation (JASDAQ) index of Japan.

3. The online product auction method according to claim 1, wherein the creation step comprises:
a step of extracting first and second digits after a decimal point of a daily stock price index and first and second digits after a decimal point of a price change from a previous day's closing; and
a step of creating a four-digit successful bid number by combining the extracted numbers.

4. The online product auction method according to claim 1, wherein the determination step further comprises a step of each of the bidders paying a predetermined bid participation fee or cyber money online.

5. The online product auction method according to claim 1, wherein:
the input step is allowed such that the input is possible only for a predetermined time; and
the extraction step is executed after the predetermined time has elapsed.

6. A computer readable, executable recording medium storing:
a program code for enabling a plurality of bidders to participate in an online auction bidding for a presented product and input respective bid numbers;
a program code for extracting specific numbers from two or more indexes selected from any of a group including a KOSPI index and a KOSDAQ index of Korea, a group including a Dow Jones index and a NASDAQ index of America, and a group including a Nikkei index and a JASDAQ index of Japan;
a program code for creating a four-digit successful bid number by combining the extracted numbers;
a program code for determining whether a bid number identical to the successful bid number exists among the bid numbers;
a program code for selecting an earliest bidder for a successful bidder if a bid number identical to the successful bid number exists, and selecting an earliest bidder having almost a same bid number for a successful bidder if no bid number identical to the successful bid number exists; and
a program code for outputting a command to deliver the corresponding product to the selected bidder.
